(19) United States
(12) Patent Application Publication
(10) Pub. No.: US 2016/0044855 A1
(43) Pub. Date: Feb. 18, 2016

(54) SHOVEL AND STEP

(71) Applicant: Tyler Lambert, Loring (CA)

(72) Inventor: Tyler Lambert, Loring (CA)

(21) Appl. No.: 14/462,005

(22) Filed: Aug. 18, 2014

(51) Int. Cl. A01B 1/02

(52) U.S. Cl. CPC A01B 1/02

(57) ABSTRACT

A shovel having a blade fixed to a shaft. A step fixed to the blade and/or the shaft, the step having a step shoulder, the step being spaced longitudinally along the shovel at a selected distance from the blade shoulder.

### FIELD OF THE INVENTION

This invention relates to a shovel. More particularly, this invention relates to a shovel that has a foot step for improved ergonomic use and a foot step that is attachable to a shovel.

### BACKGROUND OF THE INVENTION

Shovels for excavating, such as the spade or spade shovel, which will be referred to herein as the shovel, have been known for some time. A shovel is a common tool for digging, lifting, and moving bulk materials such as soil, sand, gravel, etc. Such shovels are tools that are commonly used in construction.

Most shovels are hand tools consisting of a broad blade fixed to a medium-length handle. Shovel blades are usually made of sheet steel or hard plastics and are very strong. Shovel handles are usually made of wood (especially specific varieties such as ash or maple) or glass-reinforced plastic (fibreglass).

Hand shovel blades made of sheet steel usually have a folded seam or hem at the back to make a socket for the handle. This fold also commonly provides extra rigidity to the blade. The handles are usually riveted in place.

The upper edges of the blade have blade shoulders, typically consisting of a folded seam. In order to exert force on the shovel blade, a user places a foot on the blade shoulder.

### SUMMARY OF THE INVENTION

The present invention is directed to an improved shovel and step which provide enhanced ergonomic use. The shovel and step of the current invention enables excavation to be undertaken more quickly and with less stressful impact on a user's back. The inventor has appreciated that the conventional shovel only has one position on which a user places a foot to impart force on the shovel blade.

It is an object of this invention to provide a shovel and step which reduces the stressful impact on a user's back particularly when shovelling deep excavations. The shovel and step of the current invention are particularly beneficial in that the step can be positioned at an appropriate height for a user enabling improved ergonomic posture when shovelling.

In one embodiment, the invention consists of a shovel having a blade, a shaft attached to the blade, and a step attached to one of the blade and the shaft.

In another embodiment, the invention consists of a shovel having a blade and a shaft, the blade having a tip at a first end and a socket at a second end, a shovel shoulder on each side of the socket; the shaft having a proximal end and a distal end, the proximal end fixed in the socket; and a step fixed to the blade and/or the shaft at a selected distance from the shoulders, such that in use a user applies a force to the step to work the shovel.

Preferably, the step is fixed to the socket of the blade.

Preferably, the step is fixed to the shaft proximate to the blade.

Preferably, the step comprises a first step flange and a second step flange, each of the first and second step flanges being oriented in plane and positioned orthogonal to the shaft.

Preferably, the step is adjustable in a longitudinal direction along the shaft.

Preferably, the selected distance is between 4 to 6 inches.

Preferably, a length of the shaft is and a length of the blade is between 18 and 22 inches and a length of the shaft is between 38 and 46 inches.

Preferably, a distance between a top of the step and the shoulder is between 4 to 6 inches.

Preferably, the shaft is made of a material selected from the group consisting of wood, carbon fibre, fiberglass and combinations thereof.

In another embodiment, the invention consists of a shovel blade having a tip at a first end and a socket at a second opposite end, a shovel shoulder on each side of the socket, a step being fixed to the socket at a selected distance from the shoulders.

Preferably, the selected distance is between 4 to 6 inches.

Preferably, the step is welded to the socket of the shovel blade.

Preferably, the shovel blade and step are integrally formed.

Further and other features of the invention will be apparent to those skilled in the art from the following detailed description of the embodiments thereof.

### BRIEF DESCRIPTION OF THE DRAWINGS

Reference may now be had to the following detailed description taken together with the accompanying drawings in which:

FIG. 1 shows a shovel with a step in accordance with one embodiment of the invention from a front view;

FIG. 2 shows the shovel in FIG. 1 from a rear view;

FIG. 3 shows a shovel with a step in accordance with another embodiment of the invention from a rear view;

FIG. 4 shows a shovel with a step in accordance with another embodiment of the invention from a front view the shovel in FIG. 1 from a top view;

FIG. 5 shows a shovel step in accordance with another embodiment of the invention shown in perspective view;

FIG. 6 shows a shovel step in accordance with another embodiment of the invention shown in perspective view;

FIG. 7 shows a shovel blade with a shovel step attached thereto in accordance with another embodiment of the invention shown in front view;

FIG. 8 shows the shovel blade with a shovel step attached thereto of FIG. 7 shown in rear view.

### DETAILED DESCRIPTION OF THE PREFERRED EMBODIMENTS

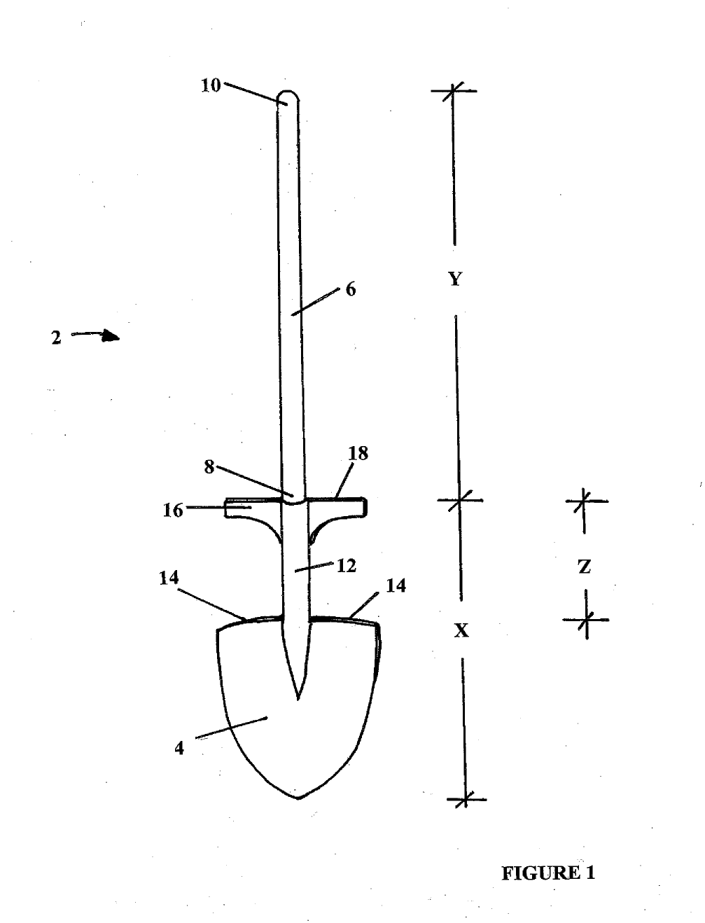

FIG. 1 shows a shovel 2 from a front view in accordance with one embodiment of the invention. The shovel 2 has a blade 4 and a shaft 6. The shaft 6 has a proximal end 8 and a distal end 10. The blade 4 has a socket 12 at one end opposite a tip of the blade. The blade 4 is attached to the shaft 6 by positioning the proximal end 8 of the shaft 6 into the socket 12 of the blade 4, and then fixing thereto using a mechanical fastener such as a nail, rivet or screw. Preferably, the shaft is made of a material such as wood, carbon fibre, fiberglass and/or combinations thereof.

The blade 4 has a blade shoulder 14 on each side of the socket 12 which can be used to apply pressure to the blade by a user's foot in a conventional manner of using a shovel. A step 16 is attached to the socket 12. The step 16 has a step shoulder 18 which can be used to apply pressure to the blade 4 and provides an ergonomically enhanced positioning for a user to apply pressure to the blade 4, in particular for taller users. Essentially, the step 16 has a first and second step flange which are oriented in plane with each other and this plane is orthogonal to the shaft 6. Preferably, the step 16 is welded to the shovel blade 4. Alternatively, the shovel blade 4 and the step 16 are integrally formed.

In a preferred embodiment, a length X from a tip of the shovel blade 4 to an opening of the socket 12 is between 18 inches and 22 inches, and more preferably between 19 and 21 inches. The step shoulder 18 is shown in FIG. 1 as being flush with the opening of the socket 12 but it is to be appreciated that this is not essential and the step shoulder 18 can be fixed at a lower position such as 1 or 2 inches below the level of the opening of the socket 12.

In a preferred embodiment, a length Y of the shaft 6 between the proximal end 8 and the distal end 10 is between 38 and 46 inches. In a preferred embodiment, a distance Z between a top of the step and the shoulder is between 4 to 6 inches.

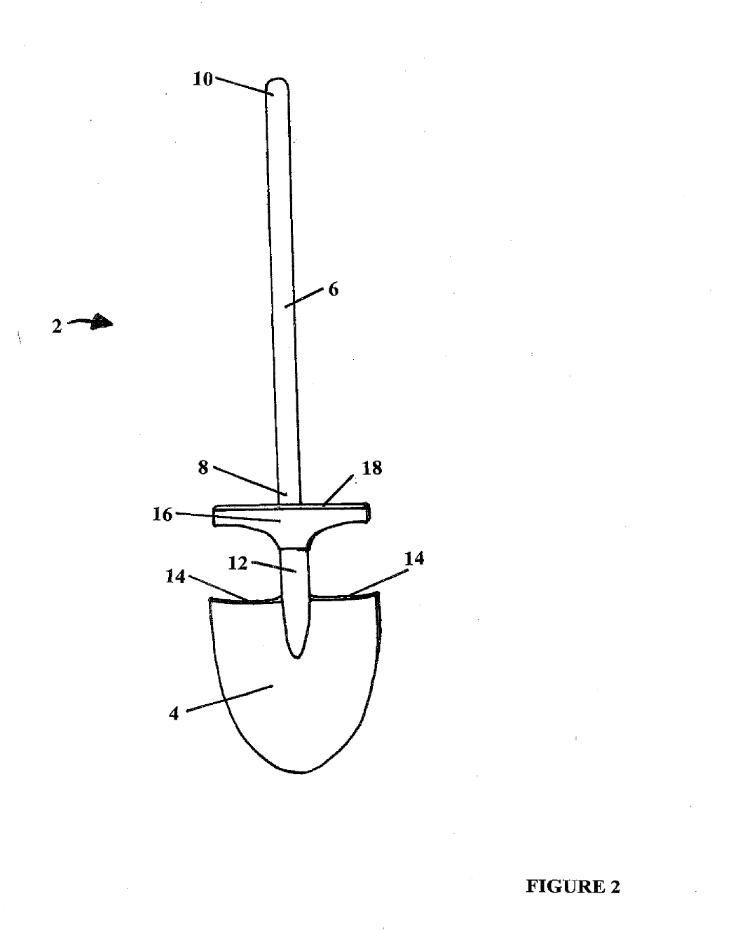

FIG. 2 shows the shovel 2 of FIG. 1 in rear view. As shown, the step 16 is generally a plate that is fixed to a rear side of the socket 12 by any means including but not limited to welding, gluing, or mechanical fasteners (not shown). The step 16 can be made of metal, fiberglass, rigid plastic or other rigid composite material that could accept a force applied by a user's foot and translate that force to the blade 4 to dig into material without cracking or breaking.

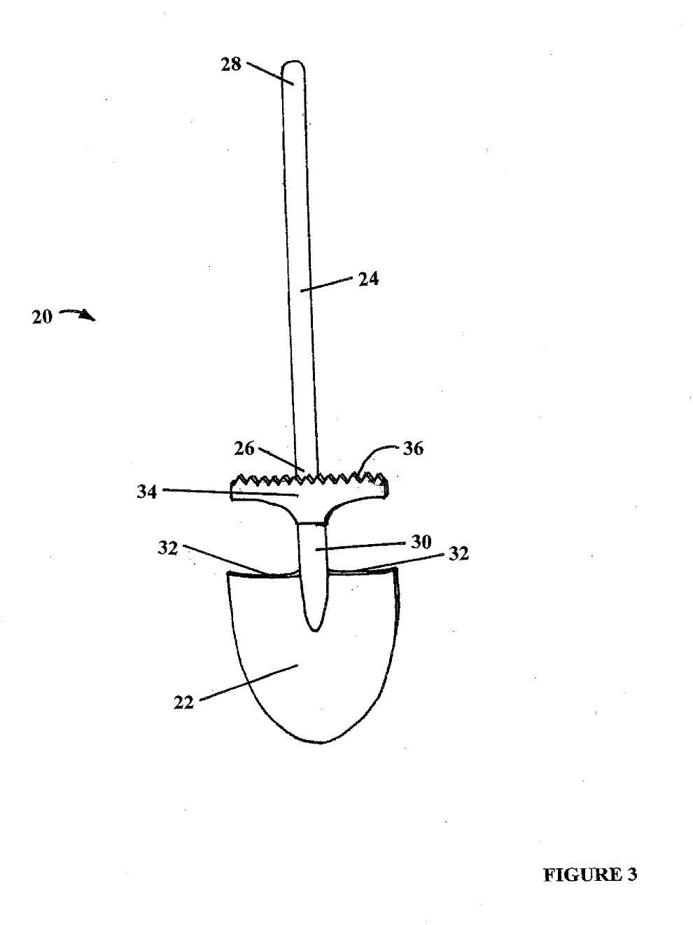

FIG. 3 shows a shovel 20 in accordance with another embodiment of the invention. The shovel 20 has a blade 22 and a shaft 24. The shaft 24 has a proximal end 26 and a distal end 28. The blade 22 has a socket 30. The proximal end 26 shaft 24 is inserted into the socket 30 and is fixed thereto by mechanical fasteners. The blade 22 has a blade shoulder 32 on each side of the socket 30. A step 34 is fixed to the socket 30 by welding, gluing or mechanical fasteners. The step 34 has a plurality of gripping protrusions 36 which provide enhanced grip with a user's foot. It is to be appreciated the gripping protrusions 36 are provided in a preferred embodiment but these are not essential to the invention.

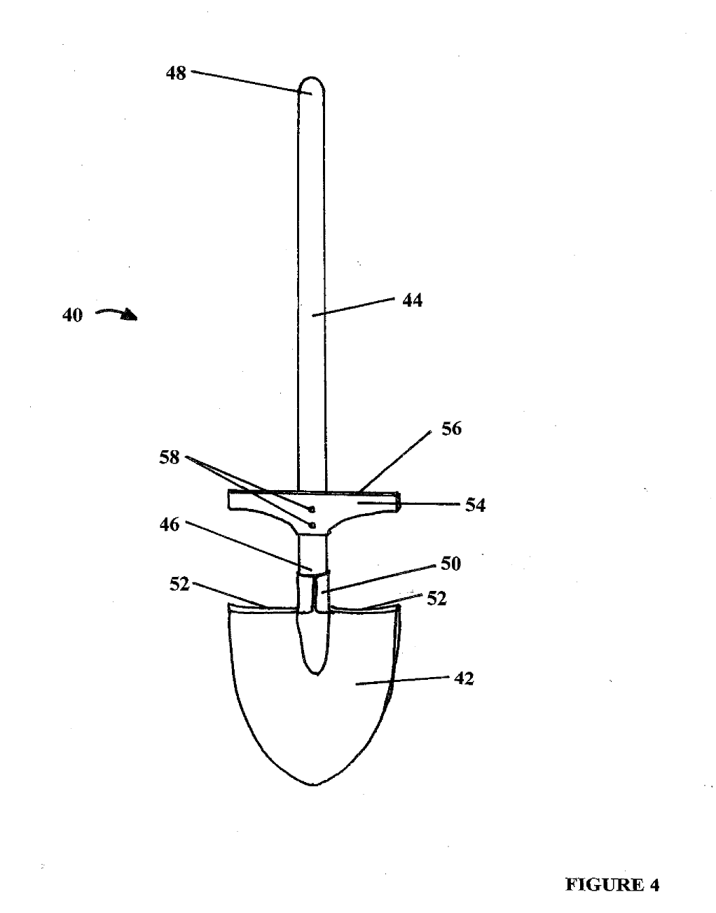

FIG. 4 shows a shovel 40 in accordance with another embodiment of the invention. The shovel 40 has a blade 42 and a shaft 44. The shaft 44 has a proximal end 46 and a distal end 48. The blade has a socket 50 with a blade shoulder 52 on each side of the socket 50. The proximal end 46 of the shaft is inserted into the socket 50 and fixed by mechanical fasteners. A step 54 has a step shoulder 56. The step 54 is fixed to the shaft 44 by mechanical fasteners 58 such as screws, nails or rivets.

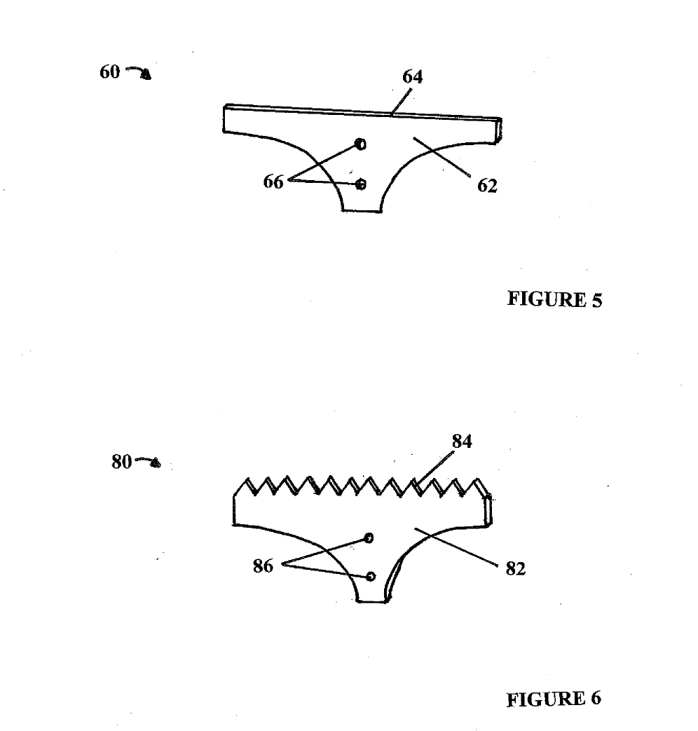

FIG. 5 shows a step 60 as shown in FIG. 4. The step 60 has flanges 62 which have a step surface 64. Two step holes 66 are provided to facilitate attachment to the shaft 44 or alternatively to the socket 46 by mechanical fasteners as may be desired.

FIG. 6 shows a step 80 in accordance with another embodiment of the invention. The step 80 has flanges 82. The flanges 82 have gripping protrusions 84 which enhance the grip of a user's footwear. It is to be appreciated that the gripping protrusion 84 are not essential to the invention. The step 80 has holes 86 to facilitate attachment to the shaft 44 or alternatively to the socket 46 by mechanical fasteners.

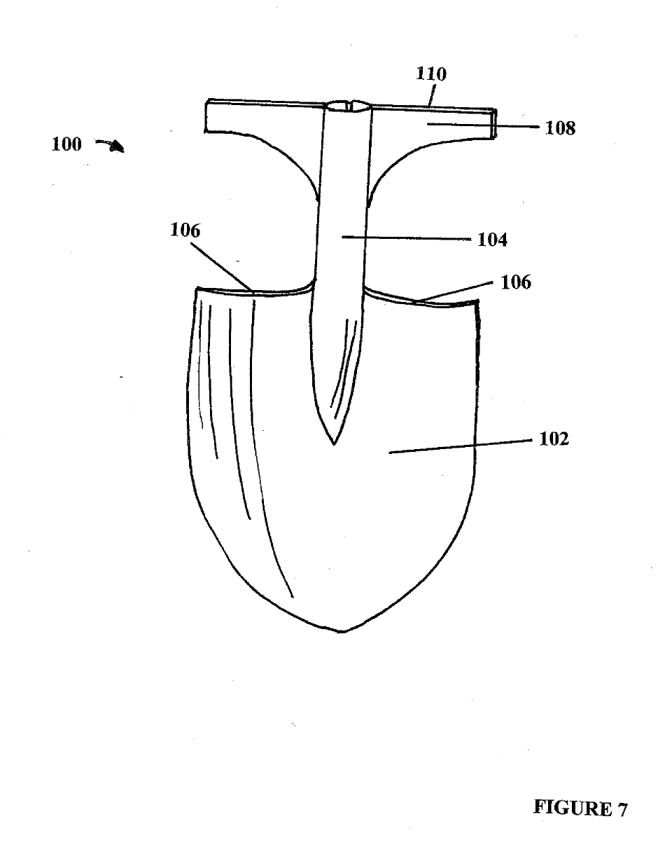

FIG. 7 shows a shovel blade with a shovel step attached thereto 100 in accordance with another embodiment of the invention shown in front view. The shovel blade 102 has a socket 104 into which a shaft or handle can be inserted and fixed. The shovel blade 102 has a blade shoulder 106 on each side of the socket 104.

A shovel step 108 is fixed to the socket 104. In a preferred embodiment, the shovel step 108 is fixed by welding. The shovel step 108 has a step shoulder 110.

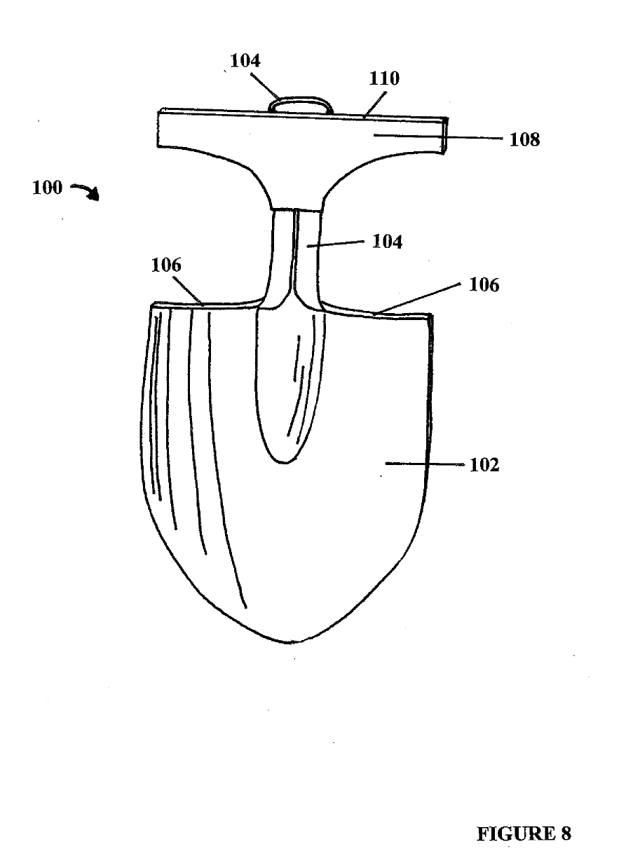

FIG. 8 shows the shovel blade with a shovel step attached thereto of FIG. 7 shown in rear view.

Although this disclosure has described and illustrated certain preferred embodiments of the invention, it is also to be understood that the invention is not restricted to these particular embodiments rather, the invention includes all embodiments which are functional, or mechanical equivalents of the specific embodiments and features that have been described and illustrated herein.

It will be understood that, although various features of the invention have been described with respect to one or another of the embodiments of the invention, the various features and embodiments of the invention may be combined or used in conjunction with other features and embodiments of the invention as described and illustrated herein.

I claim:

1. A shovel having a blade and a shaft, comprising:
the blade having a tip at a first end and a socket at a second end, a shovel shoulder on each side of the socket;
the shaft having a proximal end and a distal end, the proximal end fixed in the socket; and
a step fixed to the blade and/or the shaft at a selected distance from the shoulders, such that in use a user applies a force to the step to work the shovel.

2. The shovel of claim 1, wherein the step is fixed to the socket of the blade.

3. The shovel of claim 1, wherein the step is fixed to the shaft proximate to the blade.

4. The shovel of claim 1, wherein the step comprises a first step flange and a second step flange, each of the first and second step flanges being oriented in plane and positioned orthogonal to the shaft.

5. The shovel of claim 1, wherein the step is adjustable in a longitudinal direction along the shaft.

6. The shovel of claim 1, wherein the selected distance is between 4 to 6 inches.

7. The shovel of claim 2, wherein the selected distance is between 4 to 6 inches.

8. The shovel of claim 2, wherein a length of the shaft is and a length of the blade is between 18 and 22 inches and a length of the shaft is between 38 and 46 inches.

9. The shovel of claim 8, wherein a distance between a top of the step and the shoulder is between 4 to 6 inches.

10. The shovel of claim 1, wherein the shaft is made of a material selected from the group consisting of wood, carbon fibre, fiberglass and combinations thereof.

11. A shovel blade having a tip at a first end and a socket at a second opposite end, a shovel shoulder on each side of the socket, a step being fixed to the socket at a selected distance from the shoulders.

12. The shovel blade of claim 11, wherein the selected distance is between 4 to 6 inches.

13. The shovel blade of claim 12, wherein the step is welded to the socket of the shovel blade.

14. The shovel blade of claim 12, wherein the shovel blade and step are integrally formed.
